(19) United States
(12) Patent Application Publication
(10) Pub. No.: US 2009/0256465 A1
(43) Pub. Date: Oct. 15, 2009

(54) Green phosphor and display device including the same

(76) Inventors: Yu-Mi Song, Suwon-si (KR); Jay-Hyok Song, Suwon-si (KR); Yoon-Chang Kim, Suwon-si (KR); Do-Hyung Park, Suwon-si (KR); Yong-Chan You, Suwon-si (KR); Gyeong-Jae Heo, Suwon-si (KR); Ick-Kyu Choi, Suwon-si (KR); Mi-Ran Song, Suwon-si (KR); Seon-Young Kwon, Suwon-si (KR); Hyun-Deok Lee, Suwon-si (KR); Ji-Hyun Kim, Suwon-si (KR); Jin-Hyoung Seo, Suwon-si (KR); Sun-Hwa Kwon, Suwon-si (KR); Ji-Hyun Kim, Suwon-si (KR); Min-Ju Kim, Suwon-si (KR); Young-Hun Lee, Suwon-si (KR); Young-Ki Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/320,763

(22) Filed: Feb. 4, 2009

(30) Foreign Application Priority Data
Feb. 5, 2008 (KR) 10-2008-0011785

(51) Int. Cl. H01J 1/62; C09K 11/80; C09K 11/79

(52) U.S. Cl. 313/483; 252/301.4 R; 252/301.4 F

(57) ABSTRACT

A green phosphor including a first phosphor represented by Formula 1:

Yₐ₋ₓ₋ₖCeₖM′ₓAl_{b}O_{3/2(a+b)} (1).

In Formula 1, M′ includes at least one of Sc, Gd, In, Lu, La, and x, k, a, and b satisfy the relations 0.0≦x≦5.0, 0.0<k<0.1, 0.5≦a≦5.0, 0.5≦b≦7.0, and a-x-k >0.

### BACKGROUND

1. Field

Embodiments relate to a green phosphor and a display device including the same.

2. Description of the Related Art

A stereoscopic image from a plasma display panel (PDP) may be realized by dividing 1 TV field (16.7 ms) into two subfields, respectively producing left and right stereoscopic images, and then projecting the stereoscopic images to left and right eyes of a user wearing goggles. Optical shutters may be mounted on the left and right sides of the goggles to project the selected stereoscopic image signal to both eyes of the user by connecting the left subfield and the right subfield.

The phosphor layers in the PDP for a stereoscopic image should have a lower decay time than that of a general PDP, because the conventional 1 TV field is divided in half to provide two subfields. Particularly, phosphors having a decay time of more than 4.0 ms may cause a crosstalk phenomenon, e.g., acquiring a left subfield image by the right eye, thereby remarkably deteriorating the resolution and distinction of a stereoscopic image.

A decay time of 5 ms or less may be required for a three dimensional (“3D”) PDP. In addition, when the PDP panel is used for a long time, a severe decrease in brightness may occur relative to the red and blue phosphors. Accordingly, a green phosphor having a short decay time may be required in order to realize a stereoscopic image.

### SUMMARY

Embodiments are therefore directed to a green phosphor and a display device including the same, which substantially overcome one or more of the problems due to the limitations and disadvantages of the prior art.

It is therefore a feature of an embodiment to provide a phosphor composition for a green discharge cell having a low decay time.

It is therefore another feature of an embodiment to provide a green phosphor having excellent color quality characteristics.

It is therefore another feature of an embodiment to provide a green phosphor having excellent brightness.

It is therefore another feature of an embodiment to provide a display device for displaying three-dimensional stereoscopic images.

At least one of the above and other features and advantages may be realized by providing a green phosphor, including a first phosphor represented by Formula 1

Yₐ₋ₓ₋ₖCeₖM′ₓAl_{b}O_{3/2(a+b)} (1),

wherein, M′ includes at least one of Sc, Gd, In, Lu, La, and x, k, a, and b satisfy the relations: 0.0≦x≦5.0, 0.0<k<0.1, 0.5≦a≦5.0, 0.5≦b≦7.0, and a-x-k>0.

x, k, a, and b may satisfy the relations: 0.0≦x≦1.0, 0.01<k<0.04, 1.5≦a≦4.5, and 5.0<b≦6.0.

x, k, a, and b may satisfy the relations 2.5≦a≦3.5, 5.0<b≦6.0, and 0<(a-xk)/b<0.6.

The green phosphor may have an average particle diameter of about 5 μm or less.

The green phosphor may have an average particle diameter of about 1 μm to about 3 μm.

The green phosphor may further include a second phosphor including at least one of Zn₂SiO₄:Mn, YBO₃:Tb, (Y,Gd)Al₃(BO₃)₄:Tb, BaMgAl₁₀O₁₇:Mn, and BaMgAl₁₂O₁₉:Mn.

The first phosphor and the second phosphor may be included in a weight ratio of about 1:9 to about 4:6.

The green phosphor may have a decay time of about 1 ms or less.

The green phosphor may have a decay time of about 50 ns to about 1 ms.

The green phosphor may have a CIE (x) color coordinate of about 0.39 to about 0.43 and a CIE (y) color coordinate of about 0.54 to about 0.56.

At least one of the above and other features and advantages may also be realized by providing a display device, including a first phosphor represented by Formula 1

Yₐ₋ₓ₋ₖCeₖM′ₓAl_{b}O_{3/2(a+b)} (1),

wherein, M′ includes at least one of Sc, Gd, In, Lu, La, and x, k, a, and b satisfy the relations: 0.0≦x≦5.0, 0.0<k<0.1, 0.5≦a≦5.0, 0.5≦b≦7.0, and a-x-k>0.

x, k, a, and b may satisfy the relations: 0.0≦x≦1.0, 0.01<k<0.04, 1.5≦a≦4.5, and 5.0<b<6.0.

x, k, a, and b may satisfy the relations 2.5≦a≦3.5, 5.0<b≦6.0, and 0<(a-xk)/b<0.6.

The green phosphor may have an average particle diameter of about 5 μm or less.

The green phosphor may have an average particle diameter of about 1 μm to about 3 μm.

The green phosphor may further include a second phosphor including at least one of Zn₂SiO₄:Mn, YBO₃:Tb, (Y,Gd)Al₃(BO₃)₄:Tb, BaMgAl₁₀O₁₇:Mn, and BaMgAl₁₂O₁₉:Mn.

The first phosphor and the second phosphor may be included in a weight ratio of about 1:9 to about 4:6.

The green phosphor may have a decay time of about 1 ms or less.

The green phosphor may have a decay time of about 50 ns to about 1 ms.

The green phosphor may have a CIE (x) color coordinate of about 0.39 to about 0.43 and a CIE (y) color coordinate of about 0.54 to about 0.56.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a partial exploded perspective view of a plasma display panel according to an embodiment; and

FIG. 2 illustrates Table 1, showing the Particle diameter, Decay time, Color coordinate, and Relative luminance of Examples 1 to 5 and Comparative Examples 1 and 2.

### DETAILED DESCRIPTION

Korean Patent Application No. 10-2008-0011785, filed on Feb. 5, 2008, in the Korean Intellectual Property Office, and entitled: “Green Phosphor for Plasma Display Panel and Plasma Display Panel Including Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a flux” may represent a single compound, e.g., BaF₃, or multiple compounds in combination, e.g., BaF₃ mixed with AlF₃.

As used herein, the term “decay time” means the time for decreasing optical volume expressed from a phosphor to 1/10 of the initial optical volume.

Embodiments relate to a green phosphor having good color purity and a short decay time. Embodiments relate to a display device for realizing a three-dimensional (“3D”) stereoscopic image. Embodiments relate to a green phosphor suitable for a display device, with a decay time shorter than that of a red or blue phosphor, because the green phosphor has a wavelength that may be more easily acquired by the naked eye. The display device may include any suitable display device, e.g., a PDP. The green phosphor according to an embodiment may be a phosphor that is excited by vacuum ultraviolet (VUV) rays to emit light.

According to an embodiment, a phosphor composition may include a first phosphor represented by Formula 1:

Yₐ₋ₓ₋ₖCeₖM′ₓAl_{b}O_{3/2(a+b)} (1).

In Formula 1, M′ may include at least one of Sc, Gd, In, Lu, La. Preferably, M′ includes Gd.

In Formula 1, x, k, a, and b may satisfy the relations: 0.0≦x≦5.0, 0.0<k<0.1, 0.5≦a≦5.0, 0.5≦b≦7.0, and a-x-k>0. Preferably, x, k, a, and b satisfy the relations: 0.0≦x≦1.0, 0.01<k<0.04, 1.5≦a≦4.5, and 5.0<b≦6.0. More preferably, x, k, a, and b satisfy the relations: 2.5≦a≦3.5, 5.0<b≦6.0, and 0<(a-xk)/b<0.6. The phosphor of an embodiment may have a short decay time and excellent color purity characteristics by controlling the amount of Ce.

The green phosphor of an embodiment may have a short decay time and little decrease in brightness. The green phosphor may be used in a display device, e.g., a PDP. According to another embodiment, the green phosphor may be used in a display device driven at a high speed, e.g., about 60 Hz, 120 Hz, or higher, or in a display device for displaying a 3D stereoscopic image. The green phosphor may have a decay time of about 5 ms or less. Preferably, the decay time is about 1.0 ms or less. More preferably, the decay time is about 50 ns to about 1 ms.

The green phosphor of an embodiment may be prepared by mixing a first phosphor represented by Formula 1 and a second phosphor including at least one of Zn₂SiO₄:Mn, YBO₃:Tb, (Y,Gd)Al₃ BO₃₄:Tb, BaMgAl₁₀O₁₇:Mn, and BaAl₁₂O₁₉:Mn. The first and second phosphors may be mixed in a weight ratio of about 1:9 to about 4:6. In addition, the second phosphor may be prepared by mixing more than two phosphors in an appropriate ratio.

The green phosphor of an embodiment may have an average particle diameter of less than about 5 μm. Preferably, the green phosphor has a particle diameter of about 1 μm to about 3 μm. Maintaining the average particle diameter at about 5 μm or less may help ensure that color purity is not deteriorated and that the phosphor is able to be used in a PDP. Maintaining the average particle diameter at about 1 μm to about 3 μm may help ensure that the phosphor has improved luminance and color purity.

The green phosphor of an embodiment may have an excellent CIE color coordinate, with CIE (x) of about 0.39 to about 0.43 and CIE (y) of about 0.54 to about 0.56. A conventional green phosphor for an LED may have the same composition as a green phosphor of an embodiment, but has a particle diameter of 20 μm and a color coordinate with CIE(x) of 0.45 to 0.46 and CIE(y) of 0.52 to 0.53, resulting in deteriorated color purity.

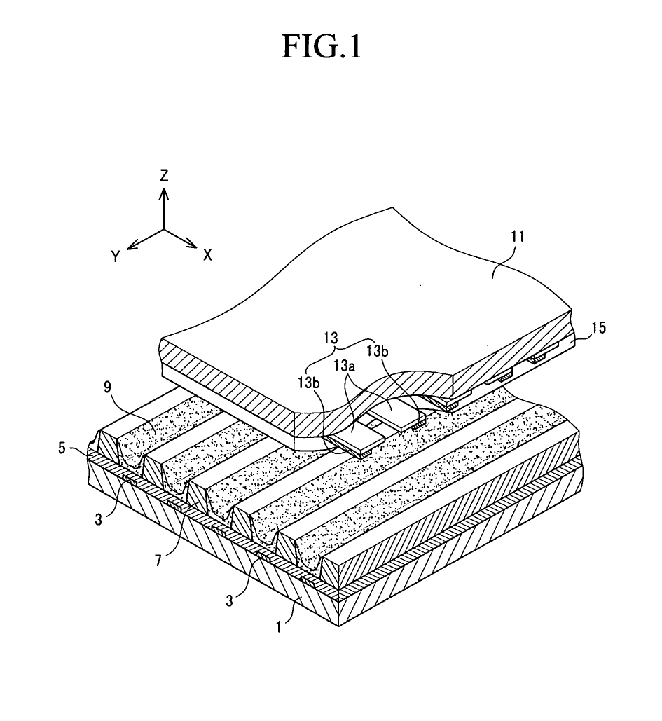

According to an embodiment, a PDP may include the green phosphor of an embodiment. FIG. 1 illustrates a partial exploded perspective view of a PDP according to an embodiment. However, the green phosphor of an embodiment is not limited to a PDP with a structure illustrated in FIG. 1, and may be used in various PDPs.

As shown in FIG. 1, the PDP may include a first substrate (rear substrate) 1 and a second substrate (front substrate) 11 that are disposed substantially in parallel with each other with a predetermined distance therebetween.

On the surface of the first substrate 1, a plurality of address electrodes 3 may be disposed in one direction (the Y direction in the drawing), and a first dielectric layer 5 may be disposed covering the address electrodes 3. A plurality of barrier ribs 7 may be formed on the first dielectric layer 5 between the address electrodes 3 at a predetermined height to form a discharge space.

The barrier ribs 7 may be formed in any suitable shape as long as the barrier ribs 7 partition the discharge space. The barrier ribs 7 may have diverse patterns. For example, the barrier ribs 7 may be formed as an open-type, e.g., a stripe, or as a closed type, e.g., a waffle, a matrix, or a delta shape. Also, the closed-type barrier ribs may be formed such that a horizontal cross-section of the discharge space may be a polygon, e.g., a quadrangle, a triangle, or a pentagon, or a circle or an oval. Red (R), green (G), and blue (B) phosphor layers 9 may be disposed in discharge cells formed between the barrier ribs 7.

Display electrodes 13, each including a transparent electrode 13a and a bus electrode 13b, may be disposed in a direction crossing the address electrodes 3 (X direction in the drawing) on one surface of the second substrate 11 facing the first substrate 1. Also, a dielectric layer 15 may be disposed on the surface of the second substrate 11 while covering the display electrodes 13.

Discharge cells may be formed at positions where the address electrodes 3 of the first substrate 1 cross the display electrodes 13 of the second substrate 11. The discharge cells may be filled with a discharge gas.

With the above-described structure, address discharge may be achieved by applying an address voltage (Va) to a space between the address electrodes 3 and any one display electrode 13. When a sustain voltage (Vs) is applied to a space between a pair of display electrodes 13, an excitation source generated from the sustain discharge may excite a corresponding phosphor layer 9 to thereby emit visible light through the transparent second substrate 11. The excitation source may include VUV rays.

The following examples illustrate embodiments in more detail. The following examples are not more than specific examples of the embodiments, and the scope is not limited by the examples.

### COMPARATIVE EXAMPLE 1

### Y₃Al₅O₁₂:Ce for LED

Yttrium oxide was mixed with alumina and ceria according to their chemical equivalent weights. Then, 3.0 wt % of a BaF₃ flux was added. The resulting mixture was fired at 1600° C. under a reduction atmosphere for 3 hours. Then, the mixture was ground, washed, dried, and sieved, to prepare a phosphor with an average particle diameter of 20 μm.

### EXAMPLE 1

Yttrium oxide was mixed with alumina and ceria according to their chemical equivalent weights. The resulting mixture was mixed with 0.5 wt % of an AlF₃ flux and then fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.001). The phosphor had an average particle diameter of 2 μm to 3 μm.

### EXAMPLE 2

Yttrium oxide was mixed with alumina and ceria according to their chemical equivalent weights. Then, 0.5 wt % of an AlF₃ flux was added. The resulting mixture was fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.005). The phosphor had an average particle diameter of 2 μm to 3 μm.

### EXAMPLE 3

Yttrium oxide was mixed with alumina and ceria according to their chemical equivalent weights. Then, 0.5 wt % of an AlF₃ flux was added. The resulting mixture was fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.010). The phosphor had an average particle diameter of 2 μm to 3 μm.

### EXAMPLE 4

Yttrium oxide was mixed with alumina and ceria according to their chemical equivalent weights. Then, 0.5 wt % of an AlF₃ flux was added. The resulting mixture was fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.030). The phosphor had an average particle diameter of 2 μm to 3 μm.

### EXAMPLE 5

Yttrium oxide was mixed with alumina and ceria according to their chemical equivalent weights. Then, 0.5 wt % of an AlF₃ flux was added. The resulting mixture was fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.070). The phosphor had an average particle diameter of 2 μm to 3 μm.

### COMPARATIVE EXAMPLE 2

Yttrium oxide was mixed with alumina and ceria according to their chemical equivalent weights. Then, 0.5 wt % of an AlF₃ flux was added. The resulting mixture was fired at 1400° C. under a reduction atmosphere for 2.5 hours. The fired mixture was ground, washed, dried, and sieved, to prepare a phosphor of Yₐ₋ₓ₋ₖCeₖM′ₓAl_{b}O_{3/2(a+b)} (a is 3, b is 5.3, x is 0, and k is 0.100). The phosphor had an average particle diameter of 2 μm to 3 μm.

It is noted that Comparative Example 2 has been provided to illustrate the effect of increasing k, and does not constitute prior art.

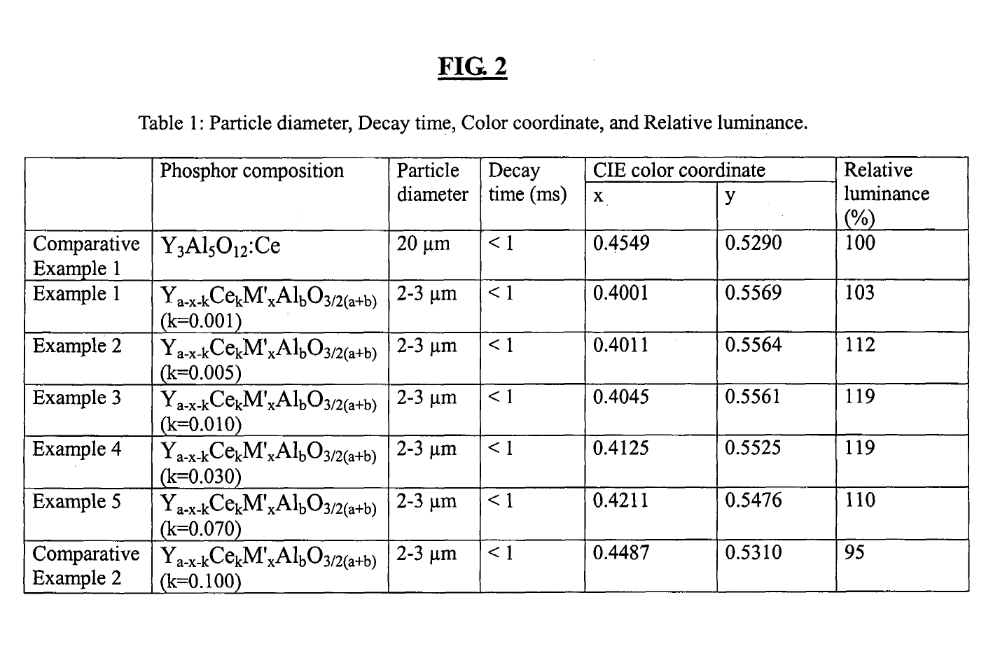

The phosphors of Examples 1 to 5 and Comparative Examples 1 to 2 were measured for their relative luminance, CIE color coordinate, and decay time. The results are shown in Table 1 of FIG. 2. Since all variables for Examples 1 to 5 and Comparative Example 2 were the same, except for k, only the k values are shown in Table 1.

The relative luminance was calculated, with the luminance (measured at 147 nm) of the Y₃Al₅O₁₂:Ce phosphor according to Comparative Example 1 considered to be 100%.

As shown in Table 1, the phosphors according to Examples 1 to 5 had excellent color purity and decay times of less than 1 ms.

On the other hand, the phosphor with a very large particle diameter, according to Comparative Example 1, had a decay time of less than 1 ms and excellent luminance, but deteriorated color purity. The phosphor including greater amounts of Ce, according to Comparative Example 2, had very low luminance as well as deteriorated color purity.

A green phosphor having a short decay time and good brightness may be useful for the next generation virtual three-dimensional stereoscopic multimedia, which may be applied to fields of, e.g., telecommunications, broadcasting, medical, education, training, military, games, animation, virtual reality, CAD, industrial technology, and so on.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A green phosphor, comprising:
a first phosphor represented by Formula 1
Yₐ₋ₓ₋ₖCeₖM′ₓAl_{b}O_{3/2(a+b)} (1),
wherein, M′ includes at least one of Sc, Gd, In, Lu, and La, and
x, k, a, and b satisfy the relations: 0.0≦x≦5.0, 0.0<k<0.1, 0.5≦a≦5.0, 0.5≦b≦7.0, and a-x-k>0.

2. The green phosphor as claimed in claim 1, wherein x, k, a, and b satisfy the relations: 0.0≦x≦1.0, 0.01<k<0.04, 1.5≦a≦4.5, and 5.0<b≦6.0.

3. The green phosphor as claimed in claim 1, wherein x, k, a, and b satisfy the relations 2.5≦a≦3.5, 5.0<b≦6.0, and 0<(a-xk)/b<0.6.

4. The green phosphor as claimed in claim 1, wherein the green phosphor has an average particle diameter of about 5 μm or less.

5. The green phosphor as claimed in claim 4, wherein the green phosphor has an average particle diameter of about 1 μm to about 3 μm.

6. The green phosphor as claimed in claim 1, further comprising a second phosphor including at least one of Zn₂SiO₄:Mn, YBO₃:Tb, (Y,Gd)Al₃(BO₃)₄:Tb, BaMgAl₁₀O₁₇:Mn, and BaMgAl₁₂O₁₉:Mn.

7. The green phosphor as claimed in claim 6, wherein the first phosphor and the second phosphor are included in a weight ratio of about 1:9 to about 4:6.

8. The green phosphor as claimed in claim 1, wherein the green phosphor has a decay time of about 1 ms or less.

9. The green phosphor as claimed in claim 8, wherein the green phosphor has a decay time of about 50 ns to about 1 ms.

10. The green phosphor as claimed in claim 1, wherein the green phosphor has a CIE (x) color coordinate of about 0.39 to about 0.43 and a CIE (y) color coordinate of about 0.54 to about 0.56.

11. A display device, comprising:
a first phosphor represented by Formula 1
Yₐ₋ₓ₋ₖCeₖM′ₓAl_{b}O_{3/2(a+b)} (1),
wherein, M′ includes at least one of Sc, Gd, In, Lu, La, and
x, k, a, and b satisfy the relations: 0.0≦x≦5.0, 0.0<k<0.1, 0.5≦a≦5.0, 0.5≦b≦7.0, and a-x-k>0.

12. The display device as claimed in claim 11, wherein x, k, a, and b satisfy the relations: 0.0≦x≦1.0, 0.01<k<0.04, 1.5≦a≦4.5, and 5.0<b≦6.0.

13. The display device as claimed in claim 11, wherein x, k, a, and b satisfy the relations 2.5≦a≦3.5, 5.0<b≦6.0, and 0<(a-xk)/b<0.6.

14. The display device as claimed in claim 11, wherein the green phosphor has an average particle diameter of about 5 μm or less.

15. The display device as claimed in claim 14, wherein the green phosphor has an average particle diameter of about 1 μm to about 3 μm.

16. The display device as claimed in claim 11, further comprising a second phosphor including at least one of Zn₂SiO₄:Mn, YBO₃:Tb, (Y,Gd)Al₃(BO₃)₄:Tb, BaMgAl₁₀O₁₇:Mn, and BaMgAl₁₂O₁₉:Mn.

17. The display device as claimed in claim 15, wherein the first phosphor and the second phosphor are included in a weight ratio of about 1:9 to about 4:6.

18. The display device as claimed in claim 11, wherein the green phosphor has a decay time of about 1 ms or less.

19. The display device as claimed in claim 18, wherein the green phosphor has a decay time of about 50 ns to about 1 ms.

20. The display device as claimed in claim 11, wherein the green phosphor has a CIE (x) color coordinate of about 0.39 to about 0.43 and a CIE (y) color coordinate of about 0.54 to about 0.56.
